(19) United States
(12) Patent Application Publication
(10) Pub. No.: US 2023/0078915 A1
(43) Pub. Date: Mar. 16, 2023

(54) WORK SEQUENCE MANAGEMENT DEVICE, WORK SEQUENCE MANAGEMENT METHOD, AND WORK SEQUENCE MANAGEMENT PROGRAM

(71) Applicant: HITACHI, LTD., Tokyo (JP)

(72) Inventors: Koji YAMASAKI, Tokyo (JP); Chiyo OHNO, Tokyo (JP)

(21) Appl. No.: 17/798,676

(22) PCT Filed: Feb. 18, 2021
(86) PCT No.: PCT/JP2021/006209

§ 371 Date: Aug. 10, 2022

(30) Foreign Application Priority Data
Mar. 17, 2020 (JP) 2020-046507

(51) Int. Cl. G06Q 10/0631

(52) U.S. Cl. CPC G06Q 10/06311

(57) ABSTRACT

A work sequence management device (1) of the present invention is characterized in including: a question processing unit (22) that acquires a question raised by a worker at a site; and a language processing unit (23) that determines whether there is necessity to present, to the worker, an intention of issuing an instruction together with the instruction for the acquired question. Further, the work sequence management device is characterized in further including an intention request unit (24) that generates an intention request for prompting generation of the intention when there is the necessity.

### TECHNICAL FIELD

The present invention relates to a work sequence management device, a work sequence management method, and a work sequence management program.

### BACKGROUND ART

In maintenance work in a plant such as a power plant, a work sequence manual is often used for a purpose of ensuring quality of the maintenance work particularly performed by an inexperienced worker. The work sequence manual is also useful for inheriting know-how from an experienced worker to the inexperienced worker.

When recognizing a maintenance target, a maintenance sequence generation device of PTL 1 displays a sequence of maintenance work for the maintenance target to a maintenance worker. When actual work content of the maintenance worker is different from the displayed sequence, the maintenance sequence generation device dynamically corrects the sequence of the maintenance work and then displays the corrected sequence to the maintenance worker. The maintenance sequence generation device updates the sequence of the maintenance work by feeding back and accumulating past experience.

### CITATION LIST

### Patent Literature

PTL 1: JP-A-2019-91368

### SUMMARY OF INVENTION

### Technical Problem

At a site, a worker may encounter a situation that the worker has not experienced in the past. Even in such a state, the maintenance sequence generation device of PTL 1 can display the sequence of the tentative maintenance work to the worker. The displayed sequence tentatively reflects knowledge of an experienced worker.

However, in such a situation, what the worker really needs is often an essential intention or the like of having to follow the sequence. When there is such information, even an inexperienced worker can have room for thinking by himself/herself, and can solve an unexperienced situation in many cases. Therefore, an object of the present invention is to allow an inexperienced worker to easily know an intention of a work sequence or the like as necessary at a site.

### Solution to Problem

A work sequence management device of the present invention is characterized in including: a question processing unit configured to acquire a question raised by a worker at a site; and a language processing unit configured to determine whether there is necessity to present, to the worker, an intention of issuing an instruction together with the instruction for the acquired question.

Other means will be described in embodiments for carrying out the invention.

### Advantageous Effects of Invention

According to the present invention, an inexperienced worker can easily know an intention of a work sequence or the like as necessary at a site.

### BRIEF DESCRIPTION OF DRAWINGS

FIG. 1 is a diagram illustrating devices used in first to fourth embodiments.

FIG. 2 is a diagram illustrating a configuration and the like of a work sequence management device according to the first and second embodiments.

FIG. 3 is an example of a work sequence manual.

FIG. 4 is an example of an intention request.

FIG. 5 is a diagram illustrating classification of questions.

FIG. 6 is a sequence diagram illustrating a process sequence according to the first and second embodiments.

FIG. 7 is a detailed flowchart of step S203.

FIG. 8 is a detailed flowchart of step S304.

FIG. 9 is the detailed flowchart (continued) of step S304.

FIG. 10 is a diagram illustrating a configuration and the like of a work sequence management device according to the third embodiment.

FIG. 11 is a sequence diagram illustrating a process sequence according to the third embodiment.

FIG. 12 is a diagram illustrating a configuration and the like of a work sequence management device according to the fourth embodiment.

FIG. 13 is a sequence diagram illustrating a process sequence according to the fourth embodiment.

### DESCRIPTION OF EMBODIMENTS

Hereinafter, a mode for carrying out the present invention (referred to as the “present embodiment”) will be described in detail with reference to the drawings and the like. The present embodiment is an example in which an inexperienced worker who works at a site communicates with an experienced worker who is at a remote location. Hereinafter, a “worker” means an inexperienced worker, and a “trainer” means an experienced worker. A feature of the present invention is to add an “intention request” to a question raised by the worker to the trainer. In response to the “intention request”, the trainer presents, to the worker, an “intention” for more essentially understanding work, in addition to a normal instruction for the question. In many cases, an answer of the trainer to the question of the worker takes a type of an “instruction” such as “please ∘∘”. The answer includes an intention of an instruction as necessary in addition to the instruction.

The present embodiment includes first to fourth embodiments, and the first to fourth embodiments can be independently carried out. A fact that the worker wears a wearable device is common to all the embodiments. The present embodiment is divided into the first to fourth embodiments depending on which device has a function (representative function) of adding an “intention request” to a question.

(Wearable Device)

The wearable device is a type of computer worn by the worker at a site. The wearable device is usually attached to glasses, a helmet, a wristwatch, or the like, or is integrated with the glasses, a helmet, a wristwatch, or the like by being incorporated therein. The wearable device includes a microphone and a speaker as an input device and an output device, and enables the worker to have a hands-free conversation. From a viewpoint of enabling the hands-free conversation, the wearable device is distinguished from a mobile terminal device such as a smartphone or a tablet.

(First to Fourth Embodiments)

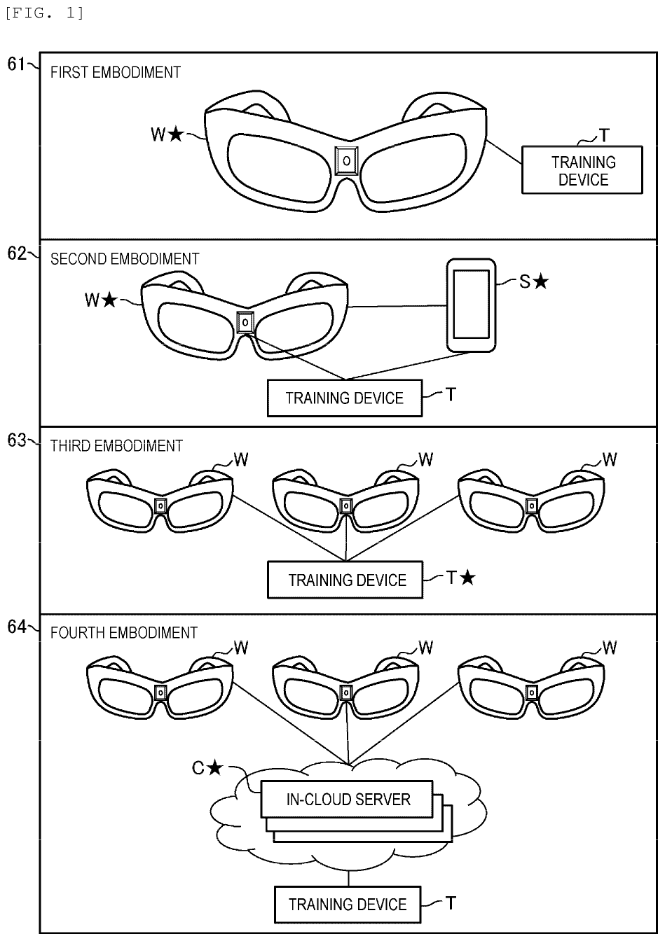

FIG. 1 is a diagram illustrating devices used in the first to fourth embodiments. In the first embodiment (column 61), a wearable device W has a shape of glasses (the same applies hereinafter), and communicates with a training device T. The wearable device W has a representative function. A symbol “★” indicates that a device has the representative function (the same applies hereinafter).

In the second embodiment (column 62), the wearable device W communicates with a mobile terminal device S and the training device T. The same worker uses the wearable device W and the mobile terminal device S simultaneously. The wearable device W and the mobile terminal device S have the representative function in a shared manner. In this case, the worker may use a software keyboard or the like of the mobile terminal device S as an input device.

In the third embodiment (column 63), the wearable devices W communicate with the training device T. The training device T has the representative function. In the column 63, the three wearable devices W are described. However, the number of wearable devices W is not an essential feature of the third embodiment. When the number of wearable devices W is large, the embodiment in which the training device T bundles a plurality of wearable devices W is preferable.

In the fourth embodiment (column 64), an in-cloud server C communicates with the wearable devices W and the training device T. The in-cloud server C is a set of one or a plurality of computer(s) disposed at an optional position in a network. The in-cloud server C including one or a plurality of housing(s) has the representative function independently or in a shared manner. The number of wearable devices W is not an essential feature of the fourth embodiment. When the number of wearable devices W is large and an existing computer can be effectively used in the network, the embodiment in which the in-cloud server C bundles a plurality of wearable devices W is preferable.

Hereinafter, the first and second embodiments will be collectively described, and then the third and fourth embodiments will be described.

### First and Second Embodiments

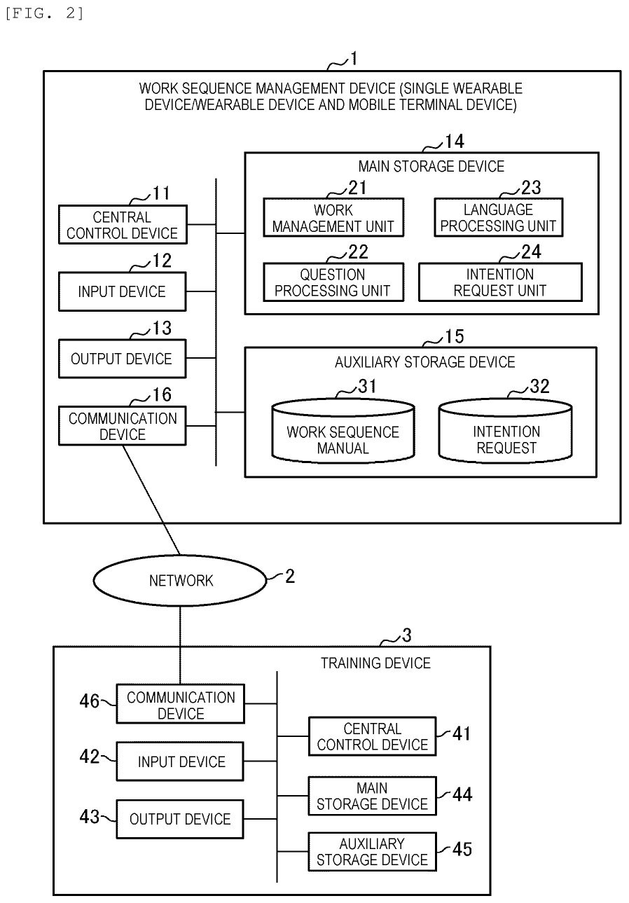

FIG. 2 is a diagram illustrating a configuration and the like of a work sequence management device 1 according to the first and second embodiments. The work sequence management device 1 is the single wearable device W in the column 61 of FIG. 1 or a combination of the wearable device W and the mobile terminal device S in the column 62 of FIG. 1. In the first embodiment, all configurations of the work sequence management device 1 in FIG. 2 are provided in the wearable device W. In the second embodiment, each configuration of the work sequence management device 1 in FIG. 2 is provided in at least any one of the wearable device W and the mobile terminal device S.

The work sequence management device 1 includes a central control device 11, an input device 12 such as a touch panel, a camera, or a microphone, an output device 13 such as a display, a spectacle lens onto which an augmented reality image is projected, or a speaker, a main storage device 14, an auxiliary storage device 15, and a communication device 16. These components are connected to one another by a bus. The auxiliary storage device 15 stores a work sequence manual 31 and an intention request 32 (both will be described in detail later).

A work management unit 21, a question processing unit 22, a language processing unit 23, and an intention request unit 24 of the main storage device 14 are programs. The central control device 11 reads these programs from the auxiliary storage device 15 and loads the programs into the main storage device 14, thereby implementing functions of the programs (described in detail later). The work sequence management device 1 can communicate with a training device 3 (reference character T in FIG. 1) via a network 2.

The training device 3 is a general computer, and includes a central control device 41, an input device 42 such as a microphone or a keyboard, an output device 43 such as a display or a speaker, a main storage device 44, an auxiliary storage device 45, and a communication device 46. The training device 3 is mainly operated by a trainer.

(Work Sequence Manual)

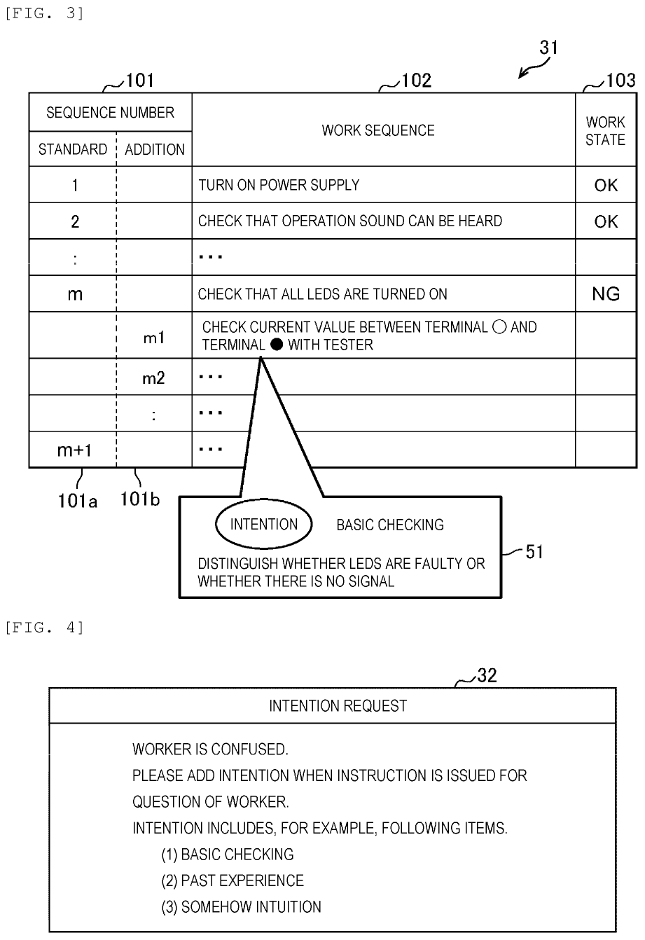

FIG. 3 is an example of the work sequence manual 31. In the work sequence manual 31, a work sequence is stored in a work sequence column 102 and a work state is stored in a work state column 103 in association with a sequence number stored in a sequence number column 101.

The sequence number in the sequence number column 101 is a number indicating an order of a work sequence to be performed by a worker at the site. The sequence number here has a hierarchy of a standard column 101a and an addition column 101b. A work sequence whose sequence number is stored in the standard column 101a is referred to as a “standard work sequence”. A work sequence whose sequence number is stored in the addition column 101b is referred to as an “additional work sequence”.

A work sequence in the work sequence column 102 is an instruction to the worker.

A work state in the work state column 103 is either “OK” or “NG”. “OK” indicates that the worker inputs information indicating that the work sequence is ended smoothly to the work sequence management device 1. “NG” indicates that the worker inputs information indicating that the work sequence is not ended smoothly to the work sequence management device 1.

The following matters can be seen with reference to FIG. 3.
At the beginning of the work, while the work state “OK” continues, the standard work sequence is displayed on the output device 13 in an order of sequence numbers (1, 2, 3, . . . ) in the standard column 101a.
At a given time point, the worker performs a standard work sequence of “checking that all LEDs are turned on” whose sequence number is “m”.
However, the worker can only check that two of three LEDs are turned on. Therefore, the worker uses the input device 12 to input “NG” in the work state column 103 whose sequence number is “m”. Although it is not clear from FIG. 3, at this time point, the worker asks a question to the training device 3 by a sound and asks for an instruction.
As a result, an additional work sequence of “checking a current value between a terminal ∘ and a terminal ● with a tester” whose sequence number is “m1” is displayed on the output device 13. In practice, the additional work sequence is output from the output device 13 as a sound of the same content.
An intention 51 is displayed on the output device 13 at the same timing. Content of the intention 51 is “basic checking: distinguish whether LEDs are faulty or whether there is no signal”.
Incidentally, at this timing, when the worker inputs “OK” in the work state column 103 whose sequence number is “m1”, a standard work sequence whose sequence number is “m+1” is displayed thereafter. When “NG” is input, an additional work sequence whose sequence number is “m2” is displayed thereafter.

Since the intention 51 is displayed to the worker, the worker can proceed with the work completely and quickly after accurately understanding the work content. In practice, it is difficult for a worker who encounters an unexperienced situation at the site to calmly request an intention from the trainer. Therefore, the work sequence management device 1 automatically transmits an “intention request” (immediately described later) to the training device 3 in a position of the worker.

(Intention Request)

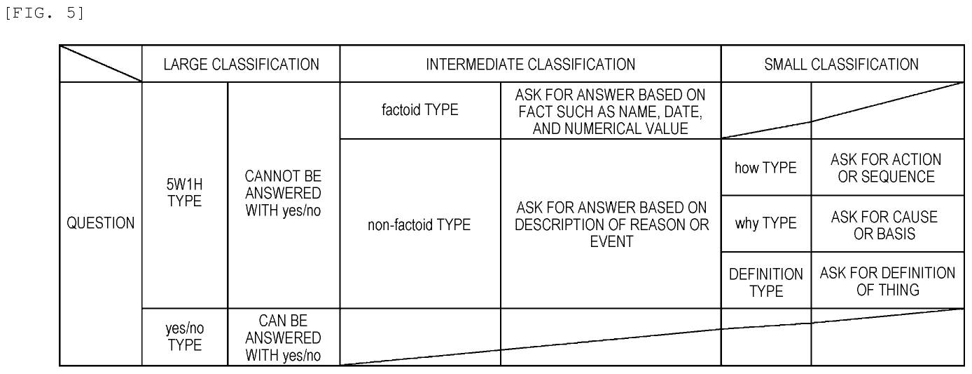

FIG. 4 is an example of the intention request 32. The intention request 32 requests the trainer to present an intention of an instruction to the worker in addition to the instruction. In many cases, the intention is a background or a purpose of the instruction. Further, the background or the purpose often includes “basic checking”, “past experience”, “somehow intuition”, and the like.

(Classification of Questions)

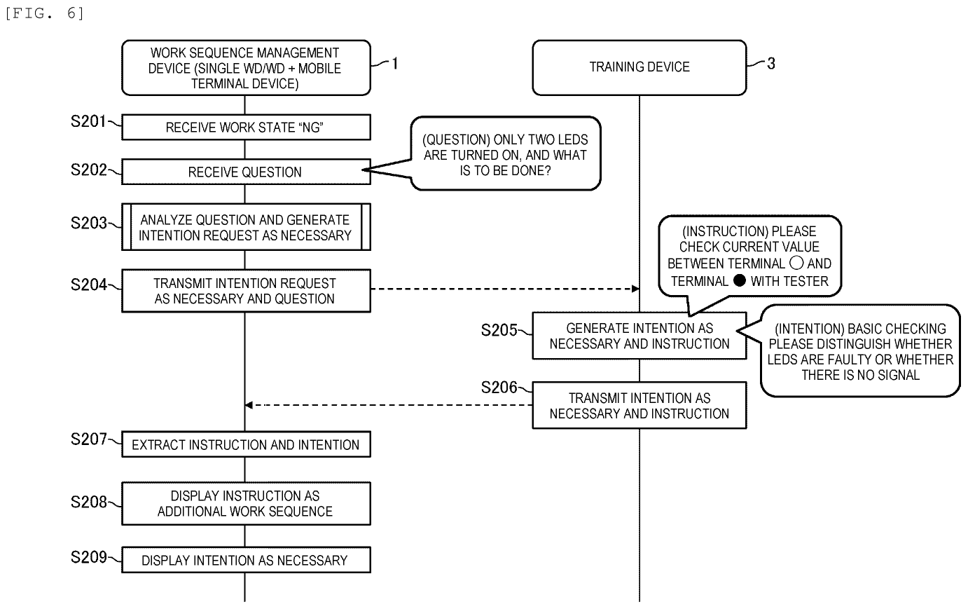

FIG. 5 is a diagram illustrating classification of questions. Questions raised to the trainer by the worker are classified into a “5W1H type” and a “yes/no type” as a “large classification”. The 5W1H type is a question that cannot be answered with yes/no. The yes/no type is a question that can be answered with yes/no.

As an “intermediate classification”, the “5W1H type” is classified into a “factoid type” and a “non-factoid type”. The factoid type is a question that asks for an answer based on a fact such as a name, a date, and a numerical value. The non-factoid type is a question that asks for an answer based on description of a reason or an event. As described above, the answer is content answered by the trainer for a question from the worker, and includes the “intention” as necessary and the “instruction”.

As a “small classification”, the “non-factoid type” is classified into a “how type”, a “why type”, and a “definition type”. The “how type” is a question that asks for an action or a sequence. The “why type” is a question that asks for a cause or a basis. The “definition type” is a question that asks for a definition of a thing.

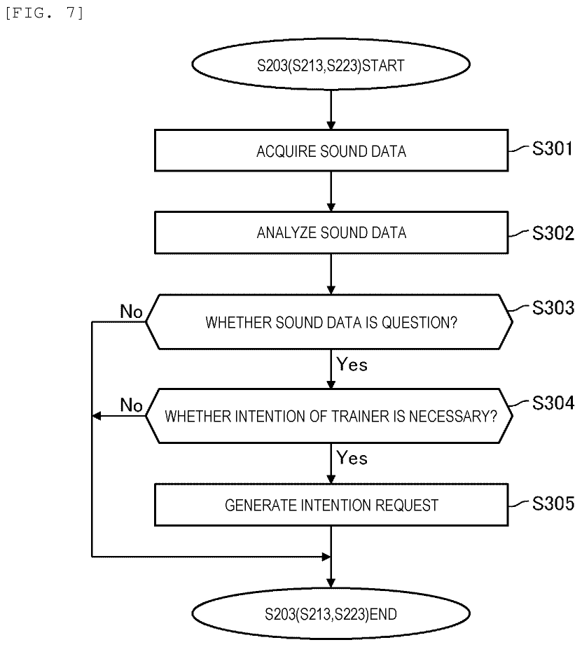

FIG. 6 is a sequence diagram illustrating a process sequence according to the first and second embodiments. “WD” is an abbreviation for the “wearable device”. As a premise of starting the process sequence, it is assumed that the work management unit 21 of the work sequence management device 1 currently displays the work sequence manual 31 (FIG. 3) on the output device 13.

In step S201, the work management unit 21 of the work sequence management device 1 receives a work state “NG”. Specifically, the work management unit 21 receives, from the worker, an input of the work state “NG” via the input device 12 such as a microphone. At this time, the worker sees that the work sequence manual 31 (FIG. 3) is projected on the spectacle lens as an augmented reality image. Then, the worker sees that a record related to a current work sequence is highlighted (for example, blinking). In this state, the worker inputs “NG” to the microphone by a sound (the same applies hereinafter).

In step S202, the work management unit 21 receives a question. Specifically, the work management unit 21 receives, from the worker, an input of the question by the sound via the input device 12 such as the microphone. The question here is, for example, “only two LEDs are turned on, and what is to be done?”.

In step S203, the work sequence management device 1 analyzes the question and creates an intention request as necessary. Details of step S203 will be described later. Here, the work sequence management device 1 determines whether to generate the intention request 32 (FIG. 4). When the intention request 32 is generated, the work sequence management device 1 stores the generated intention request 32 in the auxiliary storage device 15. Hereinafter, “as necessary” indicates that transmission of the intention request 32 and generation, transmission, and display of an intention are selective (may not be performed).

In step S204, the work management unit 21 of the work sequence management device 1 transmits the intention request 32 as necessary and the question. Specifically, the work management unit 21 transmits the question received in step S202 and the intention request 32 generated in step S203 to the training device 3. Then, the training device 3 displays the received intention request 32 on the output device 43. When the intention request 32 is not generated in step S203, the intention request 32 is not transmitted.

In step S205, the training device 3 generates an intention as necessary and an instruction. Specifically, firstly, the training device 3 generates a sound of an instruction by receiving an input of a sound to the microphone of the training device 3 from the trainer. The instruction here is, for example, “please check a current value between a terminal ∘ and a terminal ● with a tester”.

Secondly, the training device 3 generates a sound of an intention by receiving an input of a sound to the microphone of the training device 3 from the trainer. The intention here is, for example, “basic checking: please distinguish whether LEDs are faulty or whether there is no signal”. The intention is often based on, for example, a concept such as “distinguishing causes”, “preventing expansion of damage”, or “switching to another system” (the same applies hereinafter). When the intention request 32 is not generated in step S203, the intention is not generated.

It is not easy for the trainer to create an accurate reason in a short time. Therefore, the auxiliary storage device 45 of the training device 3 stores intention candidates (“whether an LED is faulty . . . ” and the like) in association with (1), (2), and (3) of FIG. 4 in advance. The training device 3 displays, on the output device 43, a “(1) basic checking” button, a “(2) past experience” button, and a “(3) somehow intuition” button. Then, the training device 3 receives a fact that the trainer presses any one of the buttons via the input device 42. Next, the training device 3 acquires an intention candidate corresponding to the pressed button from the auxiliary storage device 45 and displays the acquired intention candidate on the output device 43. Thereafter, the trainer selects one of the candidates. (The same applies to the third and fourth embodiments).

In step S206, the training device 3 transmits the intention as necessary and the instruction. Specifically, the training device 3 transmits a sound of the instruction and a sound of the intention to the work sequence management device 1. When the intention request 32 is not generated in step S203, the intention is not transmitted.

In step S207, the language processing unit 23 of the work sequence management device 1 extracts the instruction and the intention. Specifically, the language processing unit 23 extracts an instruction part and an intention part from the sounds transmitted in step S206. When the intention request 32 is not generated in step S203, the intention part is not extracted.

In step S208, the work management unit 21 of the work sequence management device 1 displays the instruction as an additional work sequence. Specifically, the work management unit 21 displays the additional work sequence of “checking a current value between a terminal ∘ and a terminal ● with a tester” in the work sequence manual 31 (FIG. 3) displayed on the output device 13, and outputs a sound of the same content from the speaker.

In step S209, the work management unit 21 displays the intention as necessary. Specifically, the work management unit 21 displays the intention of “basic checking: distinguish whether LEDs are faulty or whether there is no signal” in association with the additional work sequence of “checking a current value between a terminal ∘ and a terminal ● with a tester” displayed on the output device 13. When the intention request 32 is not generated in step S203, step S209 is omitted.

The processes of steps 5201 to 5209 are repeated each time the worker inputs the work state “NG”.

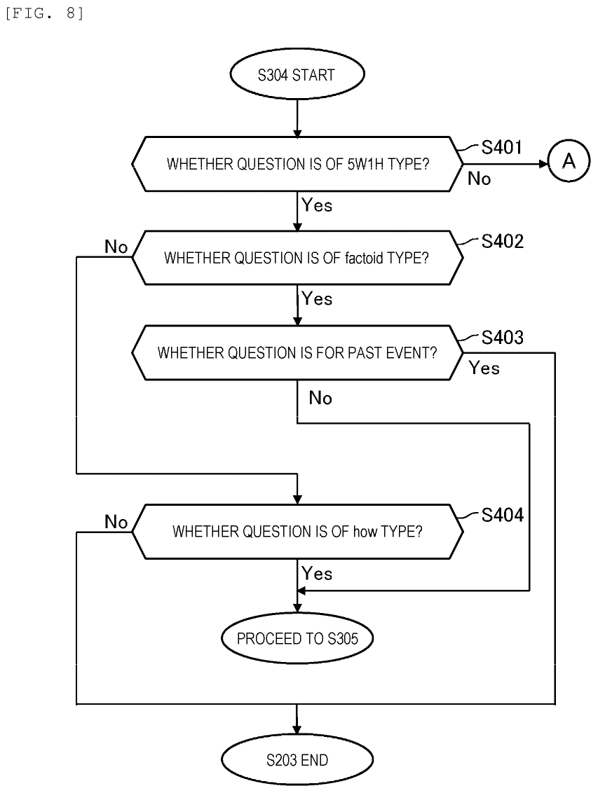

FIG. 7 is a detailed flowchart of step S203.

In step S301, the question processing unit 22 of the work sequence management device 1 acquires sound data. Specifically, the question processing unit 22 acquires a sound (time-series waveform) made toward the microphone by a user.

In step S302, the language processing unit 23 of the work sequence management device 1 analyzes the sound data. Specifically, the language processing unit 23 analyzes whether the sound data acquired in step S301 indicates a question as a natural language (corresponding to any type of FIG. 5), and generates “a question of a ∘∘ type” or “not a question” as an analysis result.

In step S303, the language processing unit 23 determines whether the sound data is a question. Specifically, the language processing unit 23 proceeds to step S304 when the analysis result of step S302 is “a question of a ∘∘type” (“Yes” in step S303) , and ends step S203 when the analysis result is “not a question” (“No” in step S303).

In step S304, the language processing unit 23 determines whether an intention of the trainer is necessary. Details of step S304 will be described later. The language processing unit 23 proceeds to step S305 when the intention is necessary as a result (“Yes” in step S304), and ends step S203 in other cases (“No” in step S304).

In step S305, the intention request unit 24 of the work sequence management device 1 generates the intention request 32 (FIG. 4). Specifically, the intention request unit 24 generates the intention request 32 (FIG. 4) and stores the generated intention request 32 in the auxiliary storage device 15.

Thereafter, step S203 ends.

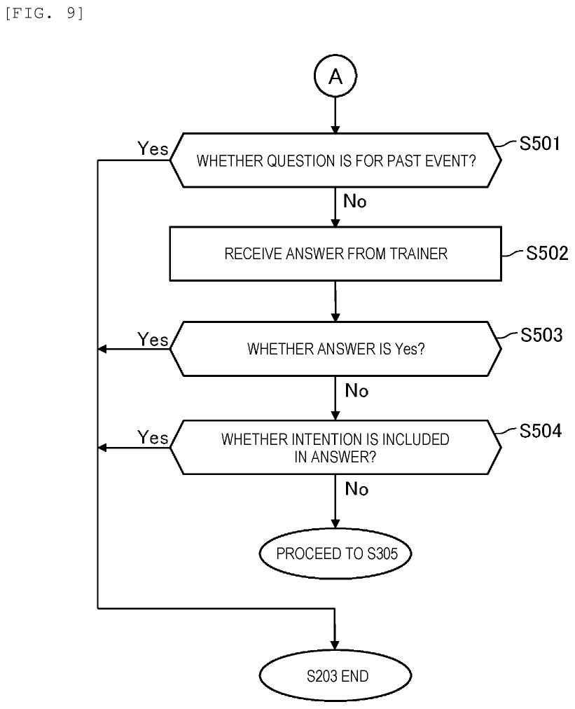

FIG. 8 is a detailed flowchart of step S304.

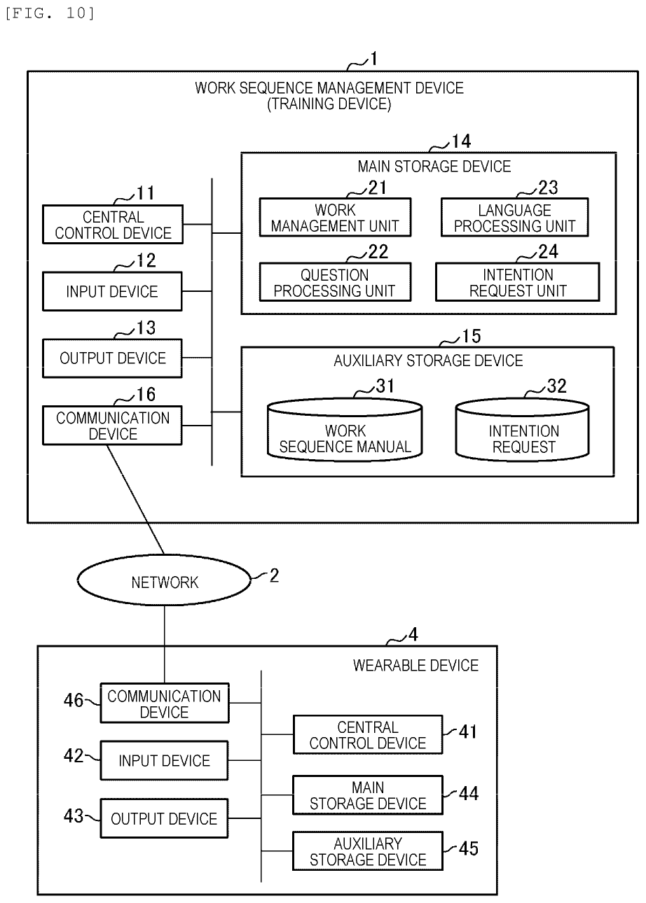

In step S401, the language processing unit 23 of the work sequence management device 1 determines whether the question is of the 5W1H type. Specifically, the language processing unit 23 proceeds to step S402 when the question is of the 5W1H type (“Yes” in step S401), and proceeds to step S501 (FIG. 9) when the question is of the yes/no type (“No” in step S401).

In step S402, the language processing unit 23 determines whether the question is of the factoid type. Specifically, the language processing unit 23 proceeds to step S403 when the question is of the factoid type (“Yes” in step S402), and proceeds to step S404 when the question is of the non-factoid type (“No” in step S402).

In step S403, the language processing unit 23 determines whether the question is for a past event. For example, in many cases, the question for a past event of “when has ∘∘∘ been done” indicates that the worker checks a fact, and therefore the intention of the trainer is not necessary. In many cases, a question for a current or future event of “when will ∘∘∘ be done” indicates that the worker asks for an intention of the trainer, and therefore the intention of the trainer is necessary. Therefore, the language processing unit 23 ends step S203 when the question is for the past event (“Yes” in step S403), and proceeds to step S305 when the question is for the current or future event (“No” in step S403).

In step S404, the language processing unit 23 determines whether the question is of the how type. When the question is of the how type, the worker often checks an action or a sequence from the trainer, and therefore the intention of the trainer is necessary. When the question is of the why type, an instruction of the trainer should be an intention of the instruction, and therefore the intention of the trainer is not necessary. Also, when the question is of the definition type, an instruction of the trainer is knowledge about terms, and therefore the intention of the trainer is not necessary. Therefore, the language processing unit 23 proceeds to step S305 when the question is of the how type (“Yes” in step S404), and ends step S203 when the question is of the why type or the definition type (“No” in step S404).

FIG. 9 is the detailed flowchart (continued) of step S304.

In step S501, the language processing unit 23 of the work sequence management device 1 determines whether the question is for the past event. For example, in many cases, the question for a past event of “whether ∘∘∘ has been done” indicates that the worker checks a fact, and therefore the intention of the trainer is not necessary. In a case of the question for the current or future event, first, an answer of the trainer (Yes or No) is necessary. Therefore, the language processing unit 23 ends step S203 when the question is for the past event (“Yes” in step S501), and proceeds to step S502 when the question is for the current or future event (“No” in step S501).

In step S502, the language processing unit 23 receives an answer from the trainer. The answer may include either “Yes” or “No”, and may also include an intention. That is, unlike the “intention” included in a reliable “answer” in accordance with the intention request 32, the trainer may semi-unconsciously give an answer with an intention by being prompted by the question of the worker.

In step S503, the language processing unit 23 determines whether the answer is Yes. For example, when an answer to a question for a current or future event of “is it advisable to ∘∘∘” is Yes, since the trainer has the same viewpoint as that of the worker, the intention of the trainer is unnecessary. When an answer to the question is No, since the trainer has a viewpoint different from that of the worker, the intention of the trainer is necessary. Therefore, the language processing unit 23 ends step S203 when the answer is Yes (“Yes” in step S503), and proceeds to step S504 when the answer is No (“No” in step S503).

In step S504, the language processing unit 23 determines whether the intention is included in the answer. For example, it is assumed that an answer to the question of “is it advisable to ∘∘∘” is “No, since there is a danger of ∘∘, please carry out ●● first”. A part of the answer, that is, “since there is a danger of ∘∘” corresponds to the intention of the trainer. It is assumed that an answer to the question of “is it advisable to ∘∘∘” is “No, please carry out ●● first”. The answer does not include a part corresponding to the intention of the trainer. Therefore, the language processing unit 23 ends step S203 when the intention is included in the answer (“Yes” in step S504), and proceeds to step S305 when the intention is not included in the answer (“No” in step S504).

### Third Embodiment

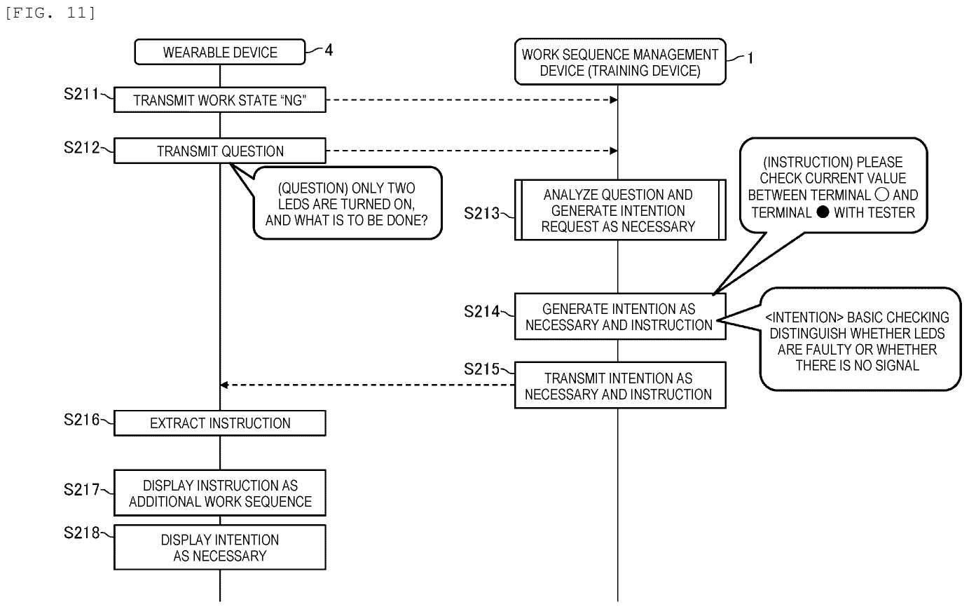

FIG. 10 is a diagram illustrating a configuration and the like of the work sequence management device 1 according to the third embodiment. The work sequence management device 1 is the training device T in the column 63 of FIG. 1. In the third embodiment, all configurations of the work sequence management device 1 in FIG. 10 are provided in the training device T. The work sequence management device 1 is mainly operated by the trainer.

Description of a configuration of the work sequence management device 1 is similar to the description of FIG. 2 of the first and second embodiments. The work sequence management device 1 can communicate with the wearable devices 4 (reference character W in the column 63 of FIG. 1) via the network 2.

The wearable device 4 is a type of computer worn by the worker at a site, and includes the central control device 41, the input device 42 such as a touch panel, a camera, or a microphone, the output device 43 such as a display, a spectacle lens onto which an augmented reality image is projected, or a speaker, the main storage device 44, the auxiliary storage device 45, and the communication device 46.

As is clear from a comparison between FIG. 2 and FIG. 10, positions of the wearable device and the training device are reversed between FIG. 2 and FIG. 10. In FIG. 2, the wearable device (or the mobile terminal device) has the representative function, whereas in FIG. 10, the training device has the representative function. For convenience of explanation, in both FIGS. 2 and 10, a configuration having the representative function is referred to as a “work sequence management device”, and reference numerals 11, 12, . . . , 21, 22, 31, and 32 are assigned to the configurations of the work sequence management device. Similarly, in both FIGS. 2 and 10, reference numerals 41 to 46 are assigned to configurations of a device that exchanges information with the “work sequence management device”.

Description of the work sequence manual 31 and the intention request 32 is similar to the description of FIGS. 3 and 4 of the first and second embodiments. Classification of questions is also similar to that in the description of FIG. 5.

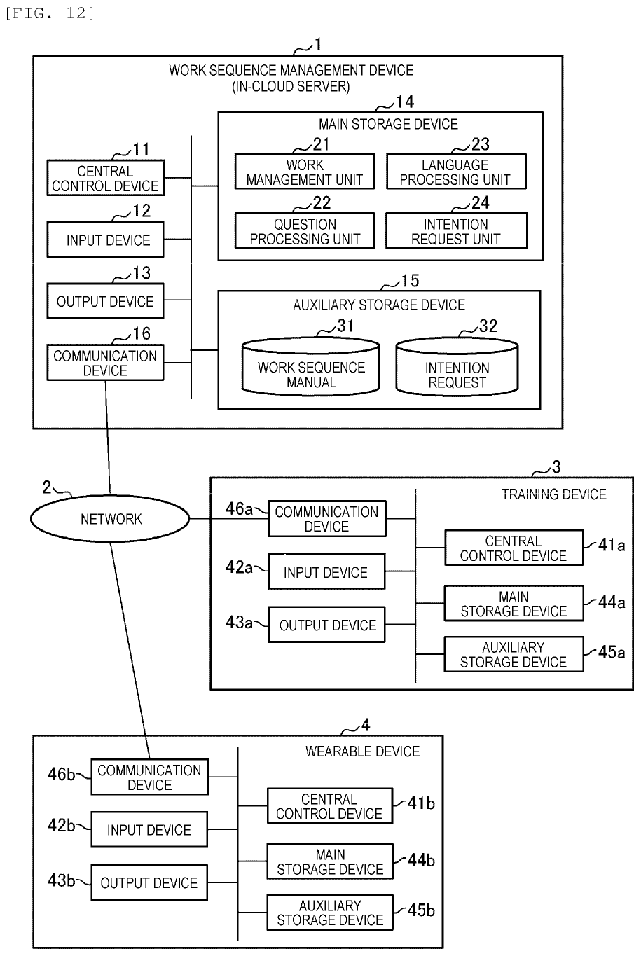

FIG. 11 is a sequence diagram illustrating a process sequence according to the third embodiment. As a premise of starting the process sequence, it is assumed that the work management unit 21 of the work sequence management device 1 currently displays the work sequence manual 31 (FIG. 3) on the output device 43 of the wearable device 4.

In step S211, the wearable device 4 transmits a work state “NG”. Specifically, firstly, the wearable device 4 receives, from the worker, an input of the work state “NG” via the input device 42 such as the microphone.

Secondly, the wearable device 4 transmits the received work state “NG” to the work sequence management device 1.

In step S212, the wearable device 4 transmits a question. Specifically, firstly, the wearable device 4 receives, from the worker, an input of the question by a sound via the input device 42 such as the microphone. The question here is, for example, “only two LEDs are turned on, and what is to be done?”.

Secondly, the wearable device 4 transmits the received question to the work sequence management device 1.

In step S213, the work sequence management device 1 analyzes the question, and creates an intention request as necessary. Details of step S213 are similar to those of the description of FIG. 7 to FIG. 9. Here, the work sequence management device 1 determines whether to generate the intention request 32 (FIG. 4). When the intention request 32 is generated, the work sequence management device 1 stores the generated intention request 32 in the auxiliary storage device 15, and displays the intention request 32 on the output device 13. Hereinafter, “as necessary” indicates that generation, transmission, and display of an intention are selective (may not be performed).

In step S214, the work management unit 21 of the work sequence management device 1 generates an intention as necessary and an instruction. Specifically, firstly, the work management unit 21 generates a sound of the instruction by receiving input of a sound to the microphone from the trainer. The instruction here is, for example, “please check a current value between a terminal ∘ and a terminal ● with a tester”.

Secondly, the work management unit 21 generates a text of an intention by receiving an input of a text (character string) to a keyboard from the trainer. The intention here is, for example, “basic checking: distinguish whether LEDs are faulty or whether there is no signal”. When the intention request 32 is not generated in step S213, the intention is not generated. “(Instruction)” indicates that the instruction is input by the sound, and “<intention>” indicates that the intention is input by the text.

In step S215, the work management unit 21 transmits the intention as necessary and the instruction. Specifically, the work management unit 21 transmits the sound of the instruction and the text of the intention to the wearable device 4. When the intention request 32 is not generated in step S213, the intention is not transmitted.

In step S216, the wearable device 4 extracts the instruction. Specifically, the wearable device 4 extracts an instruction part from the sound transmitted in step S215.

In step S217, the wearable device 4 displays the instruction as an additional work sequence. Specifically, the wearable device 4 displays an additional work sequence of “checking a current value between a terminal ∘ and a terminal ● with a tester” in the work sequence manual 31 (FIG. 3) displayed on the output device 43. The wearable device 4 may output a sound of the same content from the speaker.

In step S218, the wearable device 4 displays the intention as necessary. Specifically, the wearable device 4 displays an intention of “basic checking: distinguish whether LEDs are faulty or whether there is no signal” in association with the additional work sequence of “checking a current value between a terminal ∘ and a terminal ● with a tester” displayed on the output device 43. When the intention request 32 is not generated in step S213, step S218 is omitted.

The processes of steps S211 to S218 are repeated each time the worker inputs the work state “NG”.

### Fourth Embodiment

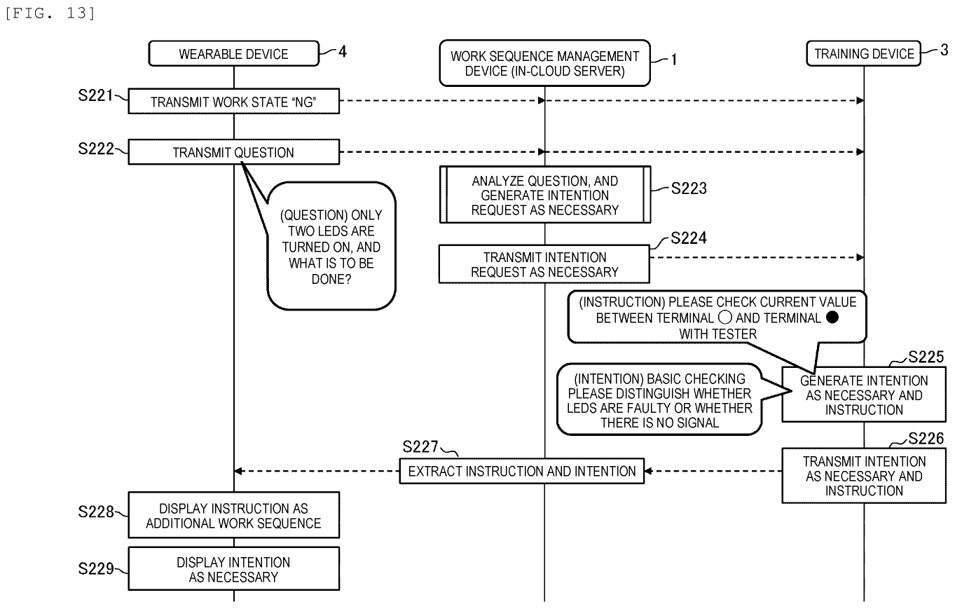

FIG. 12 is a diagram illustrating a configuration and the like of the work sequence management device 1 according to the fourth embodiment. The work sequence management device 1 is the in-cloud server C in the column 64 of FIG. 1. In the fourth embodiment, all configurations of the work sequence management device 1 in FIG. 12 are provided in at least one of a plurality of in-cloud servers C.

Description of a configuration of the work sequence management device 1 is similar to the description of FIG. 2 of the first and second embodiments. The work sequence management device 1 can communicate with the wearable devices 4 (reference character W in the column 64 of FIG. 1) and the training device 3 (reference character T in the column 64 of FIG. 1) via the network 2.

The training device 3 is a general computer, and includes a central control device 41a, an input device 42a such as a microphone or a keyboard, an output device 43a such as a display or a speaker, a main storage device 44a, an auxiliary storage device 45a, and a communication device 46a. The training device 3 is mainly operated by the trainer.

The wearable device 4 is a type of computer worn by the worker at a site, and includes a central control device 41b, an input device 42b such as a touch panel, a camera, or a microphone, an output device 43b such as a display, a spectacle lens onto which an augmented reality image is projected, or a speaker, a main storage device 44b, an auxiliary storage device 45b, and a communication device 46b.

As is clear from a comparison between FIG. 10 and FIG. 12, the configuration of the work sequence management device 1 in FIG. 10 is distributed to the work sequence management device 1 and the training device 3 in FIG. 12. Further, the work sequence management device 1 in FIG. 12 is described as one housing for convenience of explanation, but in practice, is a set of one or a plurality of computer(s) (in-cloud server) disposed at an optional position in a network. The training device in FIG. 10 has the representative function, whereas the in-cloud server in FIG. 12 has the representative function. For convenience of explanation, in both FIGS. 10 and 12, a configuration having the representative function is referred to as the “work sequence management device”, and reference numerals 11, 12, . . . , 21, 22, . . . , 31, and 32 are assigned to the configurations of the work sequence management device.

Description of the work sequence manual 31 and the intention request 32 is similar to the description of FIGS. 3 and 4 of the first and second embodiments. Classification of questions is also similar to that in the description of FIG. 5.

FIG. 13 is a sequence diagram illustrating a process sequence according to the fourth embodiment. As a premise of starting the process sequence, it is assumed that the work management unit 21 of the work sequence management device 1 currently displays the work sequence manual 31 (FIG. 3) on the output device 43b of the wearable device 4.

In step S221, the wearable device 4 transmits a work state “NG”. Specifically, firstly, the wearable device 4 receives, from the worker, an input of the work state “NG” via the input device 42b such as the microphone.

Secondly, the wearable device 4 transmits the received work state “NG” to the work sequence management device 1 and the training device 3.

In step S222, the wearable device 4 transmits a question. Specifically, firstly, the wearable device 4 receives, from the worker, an input of the question by a sound via the input device 42b such as the microphone. The question here is, for example, “only two LEDs are turned on, and what is to be done?”.

Secondly, the wearable device 4 transmits the received question to the work sequence management device 1 and the training device 3.

In step S223, the work sequence management device 1 analyzes the question, and creates an intention request as necessary. Details of step S223 are similar to those of the description of FIG. 7 to FIG. 9. Here, the work sequence management device 1 determines whether to generate the intention request 32 (FIG. 4). When the intention request 32 is generated, the work sequence management device 1 stores the generated intention request 32 in the auxiliary storage device 15. Hereinafter, “as necessary” indicates that transmission of the intention request 32 and generation, transmission, and display of the intention are selective (may not be performed).

In step S224, the work management unit 21 of the work sequence management device 1 transmits the intention request 32 as necessary. Specifically, the work management unit 21 transmits the intention request 32 generated in step S223 to the training device 3. Then, the training device 3 displays the received intention request 32 on the output device 43a. When the intention request 32 is not generated in step S223, step S224 is omitted.

In step S225, the training device 3 generates an intention as necessary and an instruction. Specifically, firstly, the training device 3 generates a sound of the instruction by receiving an input of a sound to the microphone from the trainer. The instruction here is, for example, “please check a current value between a terminal ∘ and a terminal ● with a tester”.

Secondly, the training device 3 generates a sound of an intention by receiving an input of a sound to the microphone from the trainer. The intention here is, for example, “basic checking: please distinguish whether LEDs are faulty or whether there is no signal”. When the intention request 32 is not generated in step S223, the intention is not generated.

In step S226, the training device 3 transmits the intention as necessary and the instruction. Specifically, the work management unit 21 transmits the sound of the instruction and the sound of the intention to the work sequence management device 1. When the intention request 32 is not generated in step S223, the intention is not transmitted.

In step S227, the language processing unit 23 of the work sequence management device 1 extracts the instruction and the intention. Specifically, the language processing unit 23 extracts an instruction part and an intention part from the sounds transmitted in step S226. When the intention request 32 is not generated in step S223, the intention part is not extracted.

In step S228, the wearable device 4 displays the instruction as an additional work sequence. Specifically, the wearable device 4 displays an additional work sequence of “checking a current value between a terminal ∘ and a terminal ● with a tester” in the work sequence manual 31 (FIG. 3) displayed on the output device 43b. The wearable device 4 may output a sound of the same content from the speaker.

In step S229, the wearable device 4 displays the intention as necessary. Specifically, the wearable device 4 displays an intention of “basic checking: distinguish whether LEDs are faulty or whether there is no signal” in association with the additional work sequence of “checking a current value between a terminal ∘ and a terminal with a tester” displayed on the output device 43b. When the intention request 32 is not generated in step S223, step S229 is omitted.

The processes of steps 5221 to 5229 are repeated each time the worker inputs the work state “NG”.

(First Modification)

A question of the worker may be either a sound or a text. Communication between the worker and the trainer may be performed through either the sound or the text. Input of an intention may be performed through either the sound or the text.

(Second Modification)

In the first to fourth embodiments, a camera of the wearable device 4 may acquire an image (defective image) in a field of view of the worker at a time point at which the worker inputs “NG”. Then, the intention request unit 24 of the work sequence management device 1 stores in advance a combination of a past defective image and an intention input by the trainer corresponding to the past defective image in the auxiliary storage device 15 as learning data. The intention request unit 24 uses the learning data to optimize in advance a parameter (for example, a weight between nodes) of a model (for example, a neural network type model) in which the defective image is input and the intention is output. The intention request unit 24 inputs the defective image to a learned model, and acquires an intention as an output. The intention request unit 24 may display the acquired intention to the trainer.

(Effects of Present Embodiment)

Effects of the work sequence management device of the present embodiment are as follows.

(1) The work sequence management device can determine whether the intention is necessary for an instruction for a question raised by the worker.

(2) The work sequence management device can request the trainer to create the intention.

(3) The work sequence management device can synchronize presentation of the instruction and presentation of the intention to the worker.

(4) The work sequence management device can determine necessity of the intention based on a classification result of the question.

(5) The work sequence management device can present experience of the trainer to the worker.

(6) The work sequence management device can take a form of the wearable device, a device other than the wearable device, a device in a cloud other than the wearable device, the device other than the wearable device, and the like.

The present invention is not limited to the embodiments described above, and includes various modifications. For example, the above-described embodiments have been described in detail for easy understanding of the present invention, and the present invention is not necessarily limited to those including all the configurations described above. Further, a part of a configuration of one embodiment can be replaced with a configuration of another embodiment, and the configuration of the other embodiment can be added to the configuration of one embodiment. Further, a part of the configuration of each embodiment can be added to, deleted from, or replaced with another configuration.

Some or all of the above-described configurations, functions, processing units, processing methods, and the like may be implemented by hardware, for example, by designing an integrated circuit. Further, each of the above-described configurations, functions, and the like may be implemented by software by interpreting and executing a program for implementing each function by a processor.

Information such as a program, a table, and a file for implementing each function can be stored in a recording device such as a memory, a hard disk, and a solid state drive (SSD), or a recording medium such as an IC card, an SD card, and a DVD.

Control lines and information lines show those considered to be necessary for the description, and not all the control lines and the information lines are necessarily shown on a product. In practice, it may be considered that almost all of the configurations are connected to one another.

### REFERENCE SIGNS LIST

1 work sequence management device (wearable device, training device, in-cloud server)

2 network

3 training device

4 wearable device

11 central control device

12 input device

13 output device

14 main storage device

15 auxiliary storage device

16 communication device

21 work management unit

22 question processing unit

23 language processing unit

24 intention request unit

31 work sequence manual

32 intention request

51 intention

1. A work sequence management device comprising:
a question processing unit configured to acquire a question raised by a worker at a site; and
a language processing unit configured to determine whether there is necessity to present, to the worker, an intention of issuing an instruction together with the instruction for the acquired question.

2. The work sequence management device according to claim 1, further comprising:
an intention request unit configured to generate an intention request for prompting generation of the intention when there is the necessity.

3. The work sequence management device according to claim 2, wherein
the intention request unit generates the intention request after the question is raised and before the instruction is presented.

4. The work sequence management device according to claim 3, wherein
the language processing unit determines whether there is the necessity based on a result of classifying the question.

5. The work sequence management device according to claim 4, wherein
the intention is generated by a person in a position of training the worker.

6. The work sequence management device according to claim 5, wherein
the work sequence management device is a device worn by the worker, and
the work sequence management device presents the intention together with the instruction to the worker.

7. The work sequence management device according to claim 5, wherein
the work sequence management device is a device configured to communicate with a device worn by the worker, and
the work sequence management device presents the intention together with the instruction to the device worn by the worker.

8. The work sequence management device according to claim 5, wherein
the work sequence management device is one or a plurality of device(s) configured to communicate with a device worn by the worker and a device operated by the person in the position of training, and
the work sequence management device presents the intention together with the instruction to the device worn by the worker.

9. A work sequence management method of a work sequence management device, wherein
a question processing unit of the work sequence management device acquires a question raised by a worker at a site, and
a language processing unit of the work sequence management device determines whether there is necessity to present, to the worker, an intention of issuing an instruction together with the instruction for the acquired question.

10. A work sequence management program for causing a computer to function as:
a question processing unit configured to acquire a question raised by a worker at a site; and
a language processing unit configured to determine whether there is necessity to present, to the worker, an intention of issuing an instruction together with the instruction for the acquired question.
